(19) United States
(12) Patent Application Publication
(10) Pub. No.: US 2005/0010411 A1
(43) Pub. Date: Jan. 13, 2005

(54) Speech data mining for call center management

(76) Inventors: Luca Rigazio, Santa Barbara, CA (US); Patrick Nguyen, Santa Barbara, CA (US); Jean-Claude Junqua, Santa Barbara, CA (US); Robert Boman, Thousand Oaks, CA (US)

Correspondence Address: HARNESS, DICKEY & PIERCE, P.L.C., P.O. BOX 828, BLOOMFIELD HILLS, MI, 48303, US

(21) Appl. No.: 10/616,006

(22) Filed: Jul. 9, 2003

(51) Int. Cl. G10L 15/00

(52) U.S. Cl. 704/246

(57) ABSTRACT

A speech data mining system for use in generating a rich transcription having utility in call center management includes a speech differentiation module differentiating between speech of interacting speakers, and a speech recognition module improving automatic recognition of speech of one speaker based on interaction with another speaker employed as a reference speaker. A transcript generation module generates a rich transcript based on recognized speech of the speakers. Focused, interactive language models improve recognition of a customer on a low quality channel using context extracted from speech of a call center operator on a high quality channel with a speech model adapted to the operator. Mined speech data includes number of interaction turns, customer frustration phrases, operator polity, interruptions, and/or contexts extracted from speech recognition results, such as topics, complaints, solutions, and resolutions. Mined speech data is useful in call center and/or product or service quality management.

### FIELD OF THE INVENTION

The present invention generally relates to automatic transcript generation via speech recognition, and particularly relates to mining and use of speech data based on speaker interactions to improve speech recognition and provide feedback in quality management processes.

### BACKGROUND OF THE INVENTION

The task of generating transcripts via automatic speech recognition faces many challenging issues. These issues are compounded, for example, in a call center environment, where one of the speakers may be relatively unknown and on a relatively poor audio channel due to the less than eight kilohertz signal quality limitations of today's telephone line connections. Thus, call centers have generally relied on recordings of conversations between customers and call center personnel which have a length of time, or size, indicating how long the call lasted. Also, transcriptions may have sometimes been obtained by sending the recording to an outsourced transcription service at great expense. Further, emotion detection has been employed to monitor voice stress characteristics of customers and operators and record implied emotional states in association with calls. Still further, one or more topics of conversation have been recorded in association with calls based on call center personnel's selection of topic-related electronic forms during a call, and/or customers 'explicit selection of topics via a key pad entry in response to a voice prompt at the beginning of a call. Yet further still, telephonic and other types of surveys have been employed to obtain feedback from customers relating to their experiences with consumptibles, such as products and/or services, and/or call center performance.

In general, the aforementioned efforts have been made in an attempt to obtain information useful as feedback to a call center quality management process and/or product/service quality management process, such as a product development process. For example, statistics relating to problems encountered by customers in regard to a company's consumptibles often correspond to occurrences of topics of calls at a call center. Also, information entered into an electronic form by call center personnel often identifies particular types of consumptibles, and/or details relating to problems encountered by customers. Further, lengths of calls and detected emotions serve as feedback to call center performance evaluations. Still further, electronic transcripts provides much of this information and more in a searchable format, but are expensive and time consuming to obtain and later process to extract information.

What is needed is a way to automatically generate a transcript by reliably recognizing speech of multiple speakers at a call center or in other domains where one or more speakers may not be known, or where adverse conditions affect speech of one or more speakers. What is also needed is a way to extract information from an automatically generated transcript that fills the need for rich, rapid feedback to a call center quality management process and/or product/service quality management process. The present invention fulfills this need.

### SUMMARY OF THE INVENTION

In accordance with the present invention, a speech data mining system for use in generating a rich transcription having utility in call center management includes a speech differentiation module differentiating between speech of interacting speakers, and a speech recognition module improving automatic recognition of speech of one speaker based on interaction with another speaker employed as a reference speaker. A transcript generation module generates a rich transcript based on recognized speech of the speakers.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram illustrating the speech data mining system according to the present invention;

FIG. 2 is a block diagram depicting employment of an interactive, focused language model according to the present invention;

FIG. 3 is a block diagram depicting interaction-based employment of a constraint list and rescoring mechanism in accordance with the present invention;

FIG. 4 is a block diagram depicting a first example of channel-based speaker differentiation and interaction-based improvement of speech recognition of one speaker using mined speech data of a reference speaker;

FIG. 5 is a block diagram, depicting a second example of speech data mining with interruption detection; and

FIG. 6 is a flow diagram depicting the speech data mining method in accordance with the present invention.

### DETAILED DESCRIPTION OF THE PREFERRED EMBODIMENTS

The following description of the preferred embodiment(s) is merely exemplary in nature and is in no way intended to limit the invention, its application, or uses.

By way of overview, the present invention differentiates between multiple, interacting speakers. The preferred embodiment employs a technique for differentiating between multiple, interacting speakers that includes use of separate channels for each speaker, and identification of speech on a particular channel with speech of a particular speaker. The present invention also mines speech data of speakers during the speech recognition process. Examples of speech data mined in accordance with the preferred include customer frustration phrases, operator polity phrases, and contexts such as topics, complaints, solutions, and/or resolutions. These phrases and contexts are identified based on predetermined keywords and keyword combinations extracted during speech. recognition. Additional examples of speech data mined in accordance with the preferred embodiment include detected interruptions of one speaker by another speaker, and a number of interaction turns included in a call.

The mined speech data according to the preferred embodiment has multiple uses. On one hand, some or all of the mined speech data is useful for evaluating call center and/or consumptible performance. On the other hand, some or all of the mined speech data is useful for serving as interactive context, such as context, in an interactive speech. recognition procedure. Accordingly, the present invention uses some or all of speech data mined from speech of one of the interacting speakers as context for recognizing speech of another of the interacting speakers.

In the preferred embodiment, a call center operator employing an adapted speech model and inputting speech on a relatively high quality channel is employed as a reference speaker for recognizing speech of a customer employing a generic speech model on a relatively poor quality channel. For example, if reliably detected speech of one speaker corresponds to “You're welcome,” it is reasonable to assume that the immediately previously interacting speaker is likely to have immediately previously stated a key phrase expressing appreciation, such as “Thank-you”.

Thus, the preferred embodiment generates a transcript based on the recognized speech of the multiple, interacting speakers, and records summarized and supplemented mined speech data in association with the transcript. The result is a rapid and reliable generation of a rich transcript useful in providing rich, rapid feedback to a call center quality management process and/or product/service quality management process.

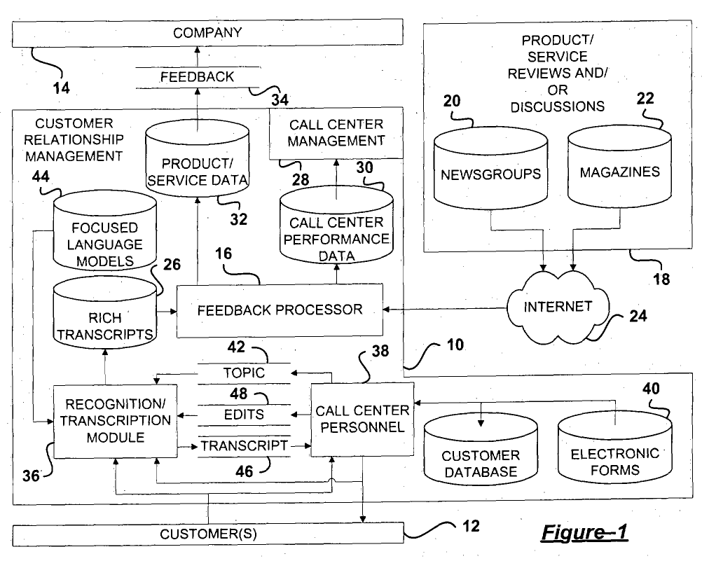

Referring now to FIG. 1, the preferred embodiment of the present invention is illustrated in an implementation with call center 10 servicing customers 12 of company 14. Call center 10 employs an integrated feedback processor 16 to search and filter product/service reviews and/or discussions 18, such as newsgroups 20 and magazines 22, over the Internet 24, and to search and filter mined speech data and transcript contents of rich transcripts 26. Feedback processor 16 employs predetermined criteria (not shown) specified by company 14 and/or internal call center management 28, to compile call center performance data 30 and/or product/service data 32. Product/service data is. communicated as feedback 34 to company 14 for use in quality control, such as product development. Similarly, call center management 28 may use call center performance data 30 to identify problems and problem sources so that appropriate measures may be taken. The rich transcripts provide company 14 and/or call center management 28 the ability to drill down into the data by actively searching the transcripts according to the mined speech data and/or actual content of the transcripts. Preferably, customer data of database 35 is associated with each transcript, so that ethnographics, demographics, psychographics, and related informative categorizations of data may be obtained.

According to the preferred embodiment, the rich transcripts are obtained by recognition and transcription module during interaction between call center personnel and customers 12. Accordingly, a dialogue module (not shown) of recognition and transcription module 36 prompts customers 12 to select an initial topic via a corresponding keypad entry at the beginning of the call. During a call, an operator of call center personnel 38 may select one or more electronic forms 40 for recording details of the call and thereby further communicate a topic 42 to recognition and transcription module 36. In turn, recognition and transcription module 36 may select one or more of focused language models 44, which are developed specifically for one or more of the predefined and indicated topics. As the call proceeds, recognition and transcription module 36 monitors both the customer and operator channels, and uses the focused language models 44 to recognize speech of both speakers and generate transcript 46, which is communicated to the operator involved in the call. In turn, the operator may communicate edits 48 for incorrectly recognized words and/or phrases to recognition and transcription module 36 during the call.

Recognized words of low confidence in the transcript 48, are highlighted on the active display of the operator to indicate the potential need for an edit or confirmation. To edit an non-highlighted word or phrase, the operator may highlight the word or phrase with a mouse click and drag. Double left clicking on a highlighted word or phrase causes a drop down menu of alternative word recognition candidates to appear for quick selection. A text box also allows the operator to type and enter the correct word or phrase if it does not appear in the list of candidates. A single right click on a highlighted word or phrase quickly and actively confirms the word or phrase and consequently increases the confidence with which the word or phrase is recognized. Also, lack of an edit after a predetermined amount of time may be interpreted as a confirmation and employed to increase the confidence of the recognition of that word or phrase in the transcript to a lesser degree than that of the active confirmation.

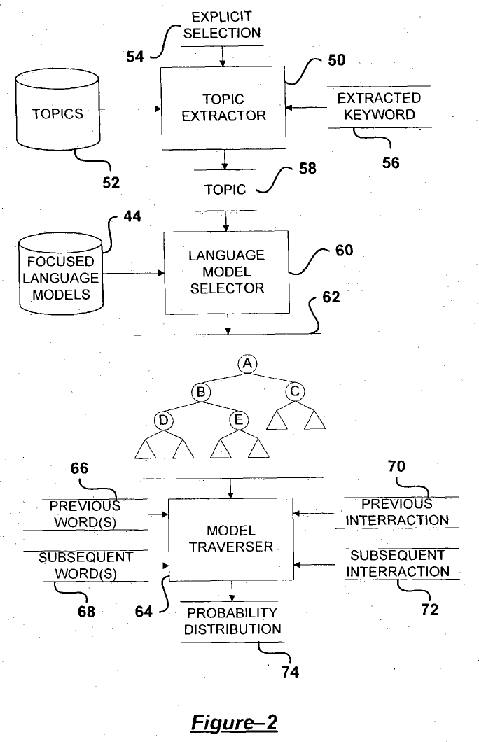

Referring now to FIG. 2, sub-components of the recognition and transcription module are illustrated. For example, a topic extractor 50 selects one of topics 52 based on an explicit topic selection 54 by a customer and/or operator, and based to a lesser degree on keywords 56 extracted frorn recognized speech during the call. Keywords 56 are continuously extracted during the call, such that a selected topic 58 may be communicated to language model selector 60 at the beginning of the call and also during the call. Language model selector 60 in turn selects one; or more of focused language models 44 based on the topic 58 or topics, and communicates the focused language model 62 to language model traverse module 64. The preferred embodiment employs focused language models in the form of binary trees wherein each non-leaf node contains a yes/no question relating to context, and each leaf node contains a probability distribution indicating what is likely to be spoken next. The use of language models is discussed in the book Robustness in Automatic Speech Recognition Fundamentals and Application, by Jean-Claude Junqua and Jean-Paul Haton (chapter 11.4, p. 356-360) © 1996, which is herein incorporated by reference. Similarly, the use of focused language models is further discussed in U.S. patent application Ser. No. 09/951,093, filed by the assignee of the present invention on Sep. 13, 2001 and herein incorporated by reference.

In the preferred embodiment, at least some of focused language models 44 are interactive in that the yes/no questions do not merely relate to context of speech the speaker, but additionally or alternatively relate to context of preceding and/or subsequent speech of another, interacting speaker. Thus, the yes/no questions may relate to keywords, contexts such as additional topics, complaints, solutions, and/or resolutions, detected interruptions, whether the context is preceding or subsequent, and/or additional types of context determinable from reliably recognized speech of the reference speaker. As a result, previous and subsequent and recognized words 66 and 68 of the speaker may be employed in addition to context of previous and subsequent interactions 70 and 72 with a reference speaker. For example, an initial model traversal and related recognition attempt is based on the previous words 66 and previous interactions 70. Later, when the subsequent words 68 and subsequent interactions are available, then model traverse module 64 selects for recognized words of low confidence to perform a subsequent model traversal and related recognition attempt based on subsequent and recognized words 66 and 68, and based on previous and subsequent interactions 70 and 72. This procedure may be performed recursively at intervals using contextually correlated speech data mined from several interaction turns. The language models may thus take into account the number of turns associated with the interactive context previous or subsequent to the turn with respect to which the recognition attempt is being performed. In any event, each traversal obtains a probability distribution 74.

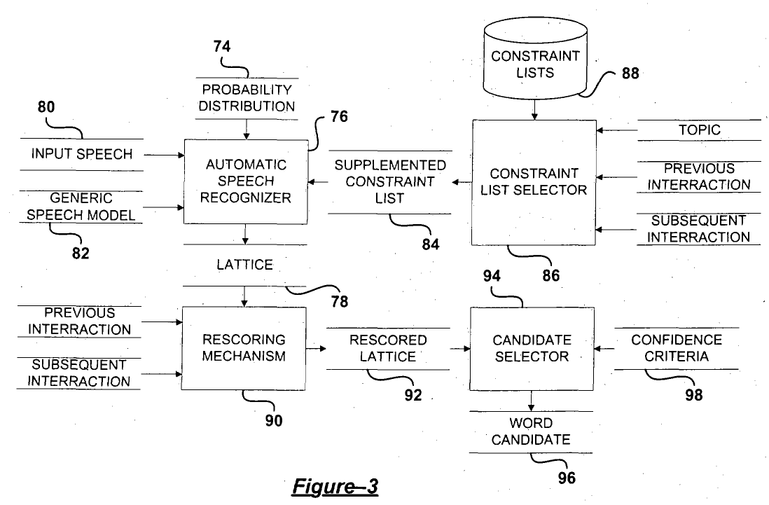

Referring now to FIG. 3, additional sub-components of the recognition and transcription module are illustrated. For example, automatic speech recognizer 76 receives probability distribution 74 and generates lattice 78, such as an N-best list of speech recognition candidates, based on input speech 80 of the customer, generic speech model 82, and supplemented constraint list 84. Also, constraint list selector 86 selects one or more of constraint lists 88 based on the one or more selected topics 58. Then, constraint list selector 86 combines plural constraint lists,: if applicable, into a single constraint list and supplements the list based on previous and subsequent interactions 70 and 72 by adding reliably recognized and extracted keywords of the interacting speaker to the list. Like the interactive language models, this procedure takes advantage of the fact that interacting speakers frequently use the same words, and that a call center operator often repeats what a customer has said. Further, rescoring mechanism 90 rescores lattice 78 based on reliably recognized and extracted keywords of previous and subsequent interactions 70 and 72. Thus, rescoring mechanism 90 generates rescored lattice 92, from which candidate selector 94 selects a particular word recognition candidate 96 based on predetermined recognition confidence criteria 98 relating to how high the confidence score of the selected candidate 96 is compared to the confidence sores of the other recognition candidates of rescored lattice 92. Thus, candidate selector 94 may confidently or tentatively select the word recognition candidate 96 to varying degrees and record the relative confidence level in association with the selected word candidate 96. This relative confidence level is then useful in determining whether to highlight the word in the transcript, attempt future recognition attempts, and/or replace the candidate with another candidate obtained in a subsequent recognition attempt.

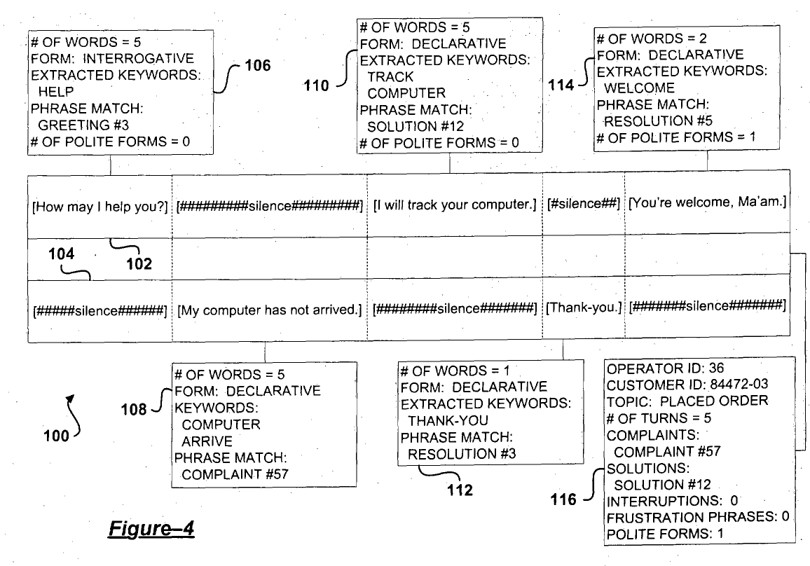

Referring now to FIG. 4, a first example of channel-based speaker differentiation and interaction-based. improvement of speech recognition of one speaker using mined speech data of a reference speaker is illustrated. For example, dual audio channels 100 include a high quality operator channel and microphone 102 and a low quality customer channel 104 and unknown microphone. Also, speech. of the operator on channel 102 is easily differentiated from speech on the customer channel 104 due to use of separate channels for each of the interacting speakers. Each interaction turn 106-114 is further detected and differentiated from each other interaction turn by presence of speech on one channel in temporal alignment with absence of speech on the other. The operator speech is reliably recognized with a speech model adapted to the operator in the usual way, while the customer speech is recognized with a generic speech model. The speech data mined and recorded in association with operator interaction turns 106, 110, and 114 is therefore treated as more reliable than speech data mined and recorded in association with customer interaction turns 108 and 112. This treatment is based on the quality of the speech model and the quality of the channel. As a result, the operator is employed as a reference speaker for assisting in recognizing speech of the customer, and mined speech data of turns 106,110, and 114 is used to improve recognition of customer speech in turns 108 and 112 so that the transcript can be generated, speech data reliably mined from the customer portion, and a summary 116 of mined speech data generated and recorded in associating with the transcript.

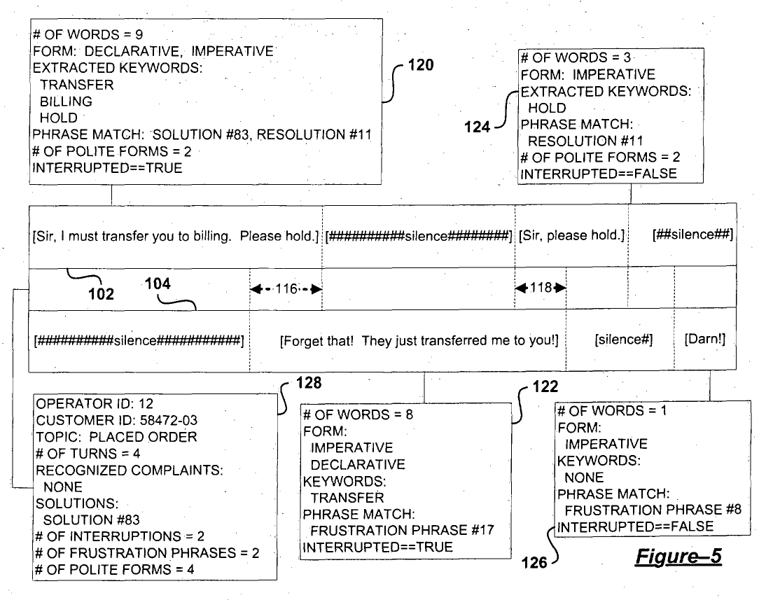

Referring now to FIG. 5, a second example of speech data mining with interruption detection is illustrated. For example, an interruption of the operator on the operator channel. 102 by the customer on the customer channel 104 is detected at 116. This detection is based on the presence of speech on the operator and customer channels 102 and 104 at the same time, and the presence of speech on the operator channel 102 and absence of speech on the customer channel 104 prior in time to when the interruption 116 began to be detected. Similarly, an interruption of the customer on the customer channel 104 by the operator on the operator channel 106 is detected at 118. This detection is based on the presence of speech on the operator and customer channels 102 and 104 at the same time, and the absence of speech on the operator channel 102 and presence of speech on the customer channel 104 prior in time to when the interruption 118 began to be detected. Each of turns 120-126 has an interruption detection flag set to true or false based on whether the turn was interrupted, and this mined speech data is summarized in summary 128.

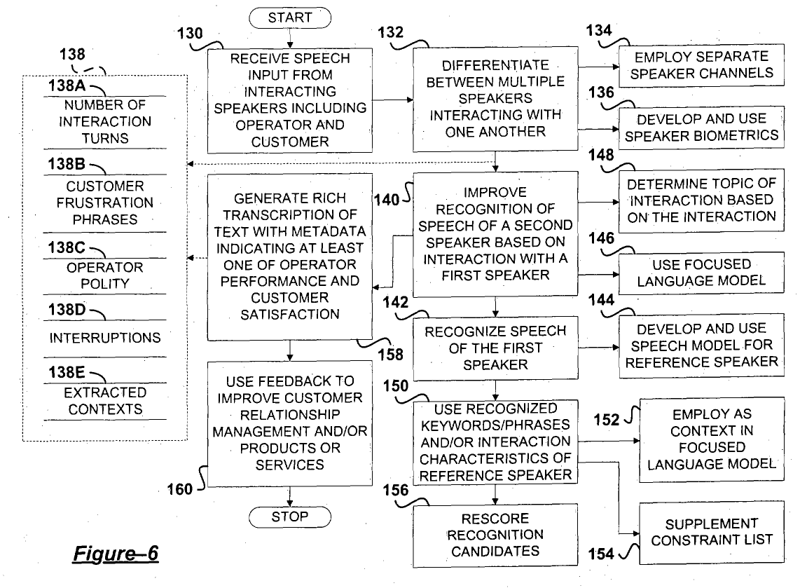

Referring now to FIG. 6, the speech data mining method according to the present invention includes receiving speech from multiple, interacting speakers at step 130, which in the preferred embodiment includes receiving speech from an operator and a customer. The multiple speakers are differentiated from one another at step 132, which in the preferred embodiment includes employing separate channels for each speaker at step 134. Alternatively or additionally, however, step 132 may include developing and/or using speaker biometrics relating to speech to differentiate between the speakers at step 136. Speech data of one or more of the speakers is mined and recorded at step 138, and the preferred embodiment mines and records number of interaction turns at step 138A, customer frustration phrases, such as negations, at step 138B, operator polity expressions at step 138C, interruptions at step 138D, and extracted contexts at step 138E, such as topics, complaints, solutions, and/or resolutions.

The method according to the present invention includes improving recognition of one speaker at step 140 based on reliably recognized speech of another, interacting speaker recognized at step 142, preferably using an adapted speech model at step 144. Preferably, focused language models are employed at step 146 based on one or more topics specified by the speakers or determined from the interaction of the speakers at step 148. According to the preferred embodiment, step, 140 includes utilizing recognized keywords, phrases and/or interaction characteristics of a reference speaker at step 150, such as data mined in step 138 from speech of the reference speaker. Step 150 includes employing the mined speech data as context in an interactive, focused, language model at step 152, supplementing a constraint list at step 154 with keywords reliably extracted from speech of the reference speaker, and/or rescoring recognition candidates at step 156 based on keywords reliably extracted from speech of the reference speaker. The method further includes generating a rich transcription at step 158 of text with metadata, such as speech data mined in step 138, which preferably indicates operator performance and/or customer satisfaction. This metadata can then be used as feedback at step 160 to improve customer relationship management and/or products and services.

The description of the invention is merely exemplary in nature and, thus, variations that do not depart from the gist of the invention are intended to be within the scope of the invention. For example, the two techniques of differentiating between multiple interacting speakers may be used in combination, especially in domains other than call centers. For example, an environment may have multiple microphones on separate channels disposed at different locations, with various speakers moving about the environment. Thus, the differentiation between speakers may in part be based on likelihood of a particular speaker to move from one channel to another, and further in part be based on use of a speech biometric useful for differentiating between the speakers. Also, the present invention may be used in courtroom transcription. In such a domain, a Judge may be employed as a reference speaker based on existence of a well-adapted speech model, and separate channels may additionally or alternatively be employed. Further, where channels are of substantially equal quality, and/or where speakers are substantially equally known or unknown, it remains possible to treat both speakers as reference speakers to one another and weight mined speech data based on confidence levels associated with the speech from which the data was mined. Further still, even where one speaker's speech is considered much more reliable than another's due to various reasons, it remains possible to employ the speaker producing the less reliable speech as a reference speaker to the more reliable speaker. In such a case, reliability of speech may be employed as a weighting factor in the recognition improvement process. Such variations are not to be regarded as a departure from the spirit and scope of the invention.

1. A speech data mining system for use in generating a rich transcription having utility in call center management, comprising:
a speech differentiation module differentiating between speech of at least two interacting speakers;
a speech recognition module improving automatic recognition of speech of a second speaker based on interaction of the second speaker with a first speaker employed as a reference speaker; and
a transcript generation module generating a rich transcript based at least in part onrecognized speech of the second speaker.

2. The system of claim 1, wherein said speech differentiation module is adapted to receive speech input from the first speaker on a first channel, to receive speech input from the second speaker on a second channel, and to differentiate between the first speaker and the second speaker by identifying speech of the first speaker with speech received on the first channel, and ideritifying speech of the second speaker with speech received on the second channel.

3. The system of claim 2, wherein said speech recognition module is adapted to employ the first speaker as the reference speaker based on quality of the first channel being higher than quality of the second channel.

4. The system of claim 1, wherein said speech recognition module is adapted to employ the first speaker as the reference speaker based on availability of a speech model adapted to the first speaker.

5. The system of claim 1, wherein speech differentiation module is adapted to at least one of:
use a speech biometric trained on speech of the first speaker to distinguish between speech of the firsf speaker and speech of another speaker; and
use a speech biometric trained on speech of the second speaker to distinguish between speech of the second speaker and speech of another speaker.

6. The system of claim 1, wherein said speech recognition module is adapted to identify a topic with respect to which the speakers are interacting, and to employ a focused language model to assist in speech recognition based on the topic.

7. The system of claim 6, wherein said speech recognition module is adapted to receive an explicit topic selection from one of the speakers.

8. The system of claim 7, wherein said speech recognition module is adapted to prompt a speaker corresponding to a call center customer to explicitly select one of a plurality of predetermined topics by pressing a corresponding button of a telephone keypad.

9. The system of claim 7, wherein said speech recognition module is adapted to identify a predetermined topic associated with an electronic form selected by call center personnel.

10. The system of claim 6, wherein said speech recognition module is adapted to extract at least one keyword from a speech recognition result of at least one of the interacting speakers, and to identify a predetermined topic based on the keyword.

11. The system of claim 1, wherein said speech recognition module is adapted to extract context from a speech recognition result of the first speaker, and to employ the context extracted from the speech recognition result of the first speaker as context in a language model utilized to assist in recognizing speech of the second speaker.

12. The system of claim 1, wherein said speech recognition module is adapted to extract at least one keyword from a speech recognition result of the first speaker, and to supplement a constraint list used in recognizing speech of the second speaker based on the keyword extracted from the speech recognition result of the first speaker.

13. The system of claim 1, wherein said speech recognition module is adapted to extract at least one keyword from a speech recognition result of the first speaker, and to rescore recognition candidates generated during recognition of speech of the second speaker based on the keyword extracted from the speech recognition result of the first speaker.

14. The system of claim 1, wherein said speech recognition module is adapted to detect interruption of speech of one speaker by speech of another speaker, and to employ the interruption as context in a language model utilized to assist in recognizing speech of the second speaker.

15. The system of claim 1, wherein said speech recognition module is adapted to detect an interruption of speech of one speaker by speech of another speaker, and to record an instance of the interruption as mined speech data.

16. The system of claim 1, wherein said speech recognition module is adapted to extract at least one keyword from a speech recognition result of at least one of the interacting speakers, to identify a frustration phrase associated with the keyword, and to record an instance of the frustration phrase as mined speech data.

17. The system of claim 1, wherein said speech recognition module is adapted to extract at least one keyword from a speech recognition result of at least one of the interacting speakers, to identify a polity expression associated with the keyword, and to record an instance of the polity expression as mined speech data.

18. The system of claim 1, wherein said speech recognition module is adapted to extract at least one keyword from a speech recognition result of at least one of the interacting speakers, to identify a context corresponding to at least one of a topic, complaint, solution, and resolution associated with the keyword, and to record an instance of the context as mined speech data.

19. The system of claim 1, wherein said speech recognition module is adapted to identify a number of interaction turns based on a shift in interaction from speaker to speaker, and to record the number of turns as mined speech data.

20. The system of claim 1, comprising a quality management subsystem employing mined speech data as feedback to at least one of a call center quality management process and a consumptible quality management process.

21. A speech data mining method for use in generating a rich transcription having utility in call center management, comprising:
differentiating between speech of at least two interacting speakers;
improving automatic recognition of speech of a second speaker based on interaction of the second speaker with a first speaker employed as a reference speaker, and
generating a rich transcript based at least in part on recognized speech of the second speaker.

22. The method of claim 21, wherein said step of differentiating between speech of at least two interacting speakers includes:
receiving speech input from the first speaker on a first channel;
receiving speech input from the second speaker on a second channel; and
differentiating between speech of the first speaker and speech of the second speaker by identifying speech of the first speaker with speech received on the first channel, and identifying speech of the second speaker with speech received on the second channel.

23. The method of claim 22, comprising employing the first speaker as a reference speaker based on quality of the first channel being higher than quality of the second channel.

24. The method of claim 21, comprising employing the first speaker as a reference speaker based on availability of a speech model adapted to the first speaker.

25. The method of claim 21, wherein said step of differentiating between speech of at least two interacting speakers includes at least one of:
using a speech biometric trained on speech of the first speaker to distinguish between speech of the first speaker and speech of another speaker; and
using a speech biometric trained on speech of the second speaker to distinguish between speech of the second speaker and speech of another speaker.

26. The method of claim 21, wherein said step of improving automatic recognition includes:
identifying a topic with respect to which the speakers are interacting; and
employing a focused language model to assist in speech recognition based on the topic.

27. The method of claim 26, wherein the step of identifying a topic includes receiving an explicit topic selection from one of the speakers.

28. The method of claim 27, wherein said step of receiving an explicit topic selection includes prompting a speaker corresponding to a call center customer to explicitly select one of a plurality of predetermined topics by pressing a corresponding button of a telephone keypad.

29. The method of claim 27, whereiri said step of receiving an explicit topic selection corresponds to identifying a predetermined topic associated with an electronic form selected by call center personnel.

30. The method of claim 26, wherein said identifying a topic includes:
extracting at least one keyword from a speech recognition result of at least one of the interacting speakers; and
identifying a predetermined topic based on the keyword.

31. The method of claim 21, wherein said step of improving automatic recognition includes:
extracting context from a speech recognition result of the first speaker; and
employing the context extracted from the speech recognition result of the first speaker as context in a language model utilized to assist, in recognizing speech of the second speaker.

32. The method of claim 21, wherein said step of improving automatic recognition includes:
extracting at least one keyword from a speech recognition result of the first speaker; and
supplementing a constraint list used in recognizing speech of the second speaker based on the keyword extracted from the speech recognition result of the first speaker.

33. The method of claim 21, wherein said step of improving automatic recognition includes:
extracting at least one keyword from a speech recognition result of the first speaker; and
rescoring recognition. candidates generated by recognition of speech of the second speaker based on the keyword extracted from the speech recognition result of the first speaker.

34. The method of claim 21, comprising detecting an interruption of speech of one speaker by speech of another speaker, wherein said step of improving automatic recognition includes employing the interruption as context in a language model utilized to assist in recognizing speech of the second speaker.

35. The method of claim 21, comprising:
detecting an interruption of speech of one speaker by speech of another speaker; and
recording an instance of the interruption as mined speech data.

36. The method of claim 21, comprising:
extracting at least one keyword from a speech recognition result of at least one of the interacting speakers;
identifying a frustration phrase associated with the keyword; and
recording an instance of the frustration phrase as mined speech data.

37. The method of claim 21, comprising:
extracting at least one keyword from a speech recognition result of at least one of the interacting speakers
identifying a polity expression associated with the keyword; and
recording an instance of the polity expression as mined speech data.

38. The method of claim 21, comprising:
extracting at least one keyword from a speech recognition result of at least one of the interacting speakers;
identifying a context corresponding to at least one of a topic, complaint, solution, and resolution associated with the keyword; and
recording an instance of the context as mined speech data.

39. The method of claim 21, comprising:
identifying a number of interaction turns based on a shift in interaction from speaker to speaker; and
recording the number of turns as mined speech data.

40. The method of claim 21, comprising employing the mined speech data as feedback to at least one of a call center quality management process and a consumptible quality management process.
